(19) United States
(12) Patent Application Publication
(10) Pub. No.: US 2011/0000056 A1
(43) Pub. Date: Jan. 6, 2011

(54) RESIN CLIP

(75) Inventors: Toshio IWAHARA, Okazaki-shi (JP); Tsuyoshi SAWADA, Toyota-shi (JP); Jyun KOMENO, Okazaki-shi (JP); Yuusuke ITOU, Okazaki-shi (JP); Haruhisa KAMIYA, Anjo-shi (JP)

Correspondence Address: PATTERSON THUENTE CHRISTENSEN PEDERSEN, P.A., 4800 IDS CENTER, 80 SOUTH 8TH STREET, MINNEAPOLIS, MN, 55402-2100, US

(73) Assignee: DAIWA KASEI KOGYO KABUSHIKI KAISHA, Okazaki-shi (JP)

(21) Appl. No.: 12/828,971

(22) Filed: Jul. 1, 2010

(30) Foreign Application Priority Data
Jul. 2, 2009 (JP) 2009-157693
May 28, 2010 (JP) 2010-122380

(51) Int. Cl. F16B 2/20; B29C 45/14

(52) U.S. Cl. 24/595.1; 264/266

(57) ABSTRACT

A resin clip may include an anchor portion, a disk portion and an annular sealing surface formed in the disk portion. The anchor portion and the disk portion are integrally formed as a unit by single-material molding using a molding die. A portion of the anchor portion is shaped by a supplemental die part of the molding die. The sealing surface is formed by a single main die part of the molding die and has a circumferentially continuous shape.

This application claims priority to Japanese patent application serial number 2009-175693 and 2010-122380, the contents of which are incorporated herein by reference.

### BACKGROUND OF THE INVENTION

1. Field of the Invention

The present invention relates to a resin clip that is used to attach an attaching member (e.g., a door trim) to a subject member (e.g., a door inner panel). More particularly, the present invention relates to a resin clip that is capable of being attached to the subject member by inserting an anchor portion thereof into an insertion hole formed in the subject member, and is capable of circumferentially sealing the insertion hole when attached to the subject member.

2. Description of Related Art

This type of resin clip is already known and is taught, for example, by JP-A-2004-278731. The resin clip includes an anchor portion (an engagement portion) that is inserted into an insertion hole formed in a subject member, and a dish-shaped disk portion (a flange portion) that is integrally formed in a proximal end of the anchor portion. Further, the disk portion is covered by a sealing pad that is made of an elastic material (e.g., elastomer). The sealing pad includes a skirt portion that is flared outwardly. The skirt portion can be pressed against a surface of the subject member when the anchor portion is inserted into the insertion hole, so as to circumferentially seal the insertion hole.

In the resin clip taught by JP-A-2004-278731, the sealing pad made of elastmer is formed in the disk portion by two-color (two-material) molding. This may lead to increased manufacturing costs of the resin clip. Further, it is highly possible that the sealing pad thus formed is separated from the disk portion. This may lead to reduction of sealing performance of the disk portion.

An additional resin clip is also known. The resin clip includes an anchor portion and a disk portion that are integrally formed. In the resin clip, the disk portion is shaped to have increased flexibility. The disk portion thus formed can be pressed against a surface of a subject member when the anchor portion is inserted into an insertion hole. Thus, the disk portion can circumferentially seal the insertion hole. However, the disk portion generally has radially-extending uneven portions that can be formed in a sealing surface thereof when the resin clip is molded. Therefore, the sealing surface of the disk portion can substantially be partly broken divided by the radially-extending uneven portions. That is, the sealing surface cannot continuously contact the surface of the subject member. As a result, the disk portion cannot have sufficient sealing performance.

Thus, there is a need in the art for improved resin clips.

### SUMMARY OF THE INVENTION

For example, in one embodiment of the present invention, a resin clip may include an anchor portion that is arranged and constructed to be inserted into an insertion hole formed in a subject member, a disk portion that is positioned around a proximal end portion of the anchor portion, and an annular sealing surface that is formed in the disk portion. The anchor portion and the disk portion are integrally formed as a unit by single-material molding using a molding die. A portion of the anchor portion is shaped by a supplemental die part of the molding die. The sealing surface is formed by a single main die part of the molding die and has a circumferentially continuous shape that is centered on a longitudinal axis of the anchor portion. The disk portion is arranged and constructed to be pressed to the surface of the subject member when the anchor portion is inserted into the insertion hole of the subject member, so that the sealing surface can circumferentially continuously contact the surface of the subject member around the insertion hole.

According to this embodiment, the annular sealing surface does not have radially-extending uneven portions. That is, the sealing surface is not divided. Therefore, when the anchor portion is inserted into the insertion hole of the subject member, the sealing surface can circumferentially continuously contact the surface of the subject member around the insertion hole. Thus, the disk portion can have sufficient sealing performance around the insertion hole of the subject member.

Also, the resin clip having such a sealing surface can be manufactured by single-material molding. Therefore, it is not necessary to additionally provide a rubber packing to the disk portion or to additionally form a sealing member of an elastic material in the disk portion by two-material molding. This may lead to reduced manufacturing costs of the resin clip. Further, sealing performance of the disk portion can be reliably maintained because the disk portion does not have the rubber packing or the sealing member that can be easily removed or separated therefrom.

Optionally, the sealing surface may have a plurality of annular deformed portions that are concentrically positioned about the longitudinal axis of the anchor portion.

Further, the sealing surface may have an annular thickened portion that continuously extends along an outer circumferential periphery thereof.

Other objects, features and advantages of the present invention will be readily understood after reading the following detailed description together with the accompanying drawings and the claims.

### BRIEF DESCRIPTION OF THE DRAWINGS

FIG. 1 is a perspective view of a resin clip according to a first representative embodiment of the present invention;

FIG. 2 is an elevational view of the resin clip;

FIG. 3 is a plan view of the resin clip;

FIG. 4 is a partially sectional view of the resin clip, which view illustrates a condition in which the resin clip is attached to a subject member;

FIG. 5 is a perspective view of the resin clip, which view illustrates a condition in which the resin clip is formed in a molding die;

FIG. 6 is a vertically sectional view of FIG. 5;

FIG. 7 is a perspective view of an upper die element of the molding die, which view is seen from a mating surface side thereof;

FIG. 8(A) is a partially sectional view of the resin clip, which view illustrates a first modified form of a disk portion;

FIG. 8(B) is a partially sectional view of the resin clip, which view illustrates a second modified form of the disk portion;

FIG. 8(C) is a partially sectional view of the resin clip, which view illustrates a third modified form of the disk portion;

FIG. 8(D) is a partially sectional view of the resin clip, which view illustrates a fourth modified form of the disk portion thereof;

FIG. 9 is a perspective view of a resin clip according to a second representative embodiment of the present invention;

FIG. 10 is a partially enlarged view of a disk portion of the resin clip shown in FIG. 9;

FIG. 11(A) is a view similar to FIG. 10, which view illustrates a first modified form of the disk portion;

FIG. 11(B) is a view similar to FIG. 10, which view illustrates a second modified form of the disk portion;

FIG. 11(C) is a view similar to FIG. 10, which view illustrates a third modified form of the disk portion;

FIG. 11(D) is a view similar to FIG. 10, which view illustrates a fourth modified form of the disk portion;

FIG. 12 is a perspective view of a conventional resin clip, which view illustrates a condition in which the resin clip is formed in a conventional molding die; and

FIG. 13 is a plan view of FIG. 12, which view illustrates a condition in which the conventional molding die is opened.

### DETAILED DESCRIPTION OF THE INVENTION

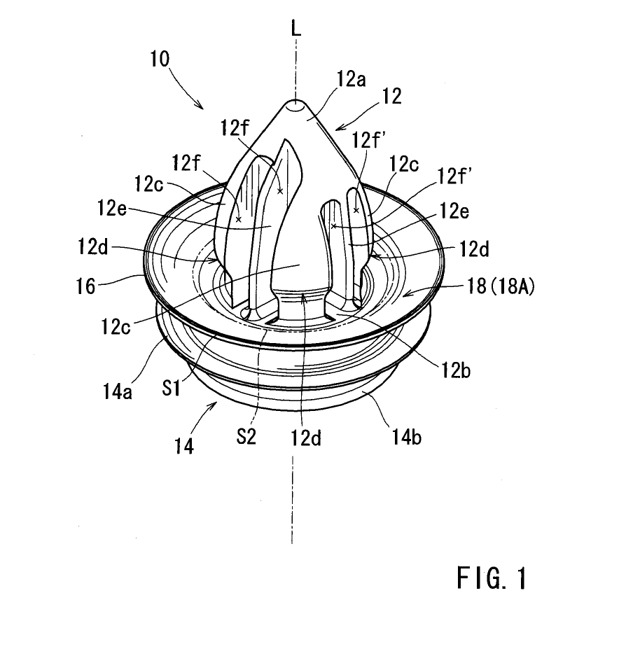

A first detailed representative embodiment of the present invention will be described with reference to FIGS. 1 to 8.

As shown in FIGS. 1 to 3, a representative resin clip 10 may preferably include an upper anchor portion 12, a lower connecting portion 14, and a disk portion 16 that is positioned between the anchor portion 12 and the connecting portion 14. The resin clip 10 may preferably be integrally formed as a unit by single-material (single-color) molding using a molding die 40, which will be hereinafter described.

The anchor portion 12 may preferably include a distal end portion 12a, and a proximal end portion 12b that is connected to the disk portion 16. The anchor portion 12 is partially removed vertically to form a plurality of (four in this embodiment) vertical flexible strip portions 12c and a plurality of (four in this embodiment) vertical support strip portions 12e. The flexible strip portions 12c respectively extend from the proximal end portion 12b toward the distal end portion 12a. Further, as best shown in FIG. 3, the flexible strip portions 12c are positioned circumferentially at equal intervals.

The distal end portion 12a of the anchor portion 12 is formed into a cone-shaped solid portion (block). Conversely, the proximal end portion 12b has substantial rigidity so as to function as a base portion of the resin clip 10. Each of the flexible strip portions 12c is connected to the distal end portion 12a and the proximal end portion 12b at both ends thereof, so as to be flexed inwardly toward a longitudinal axis L of the anchor portion 12 due to elasticity thereof.

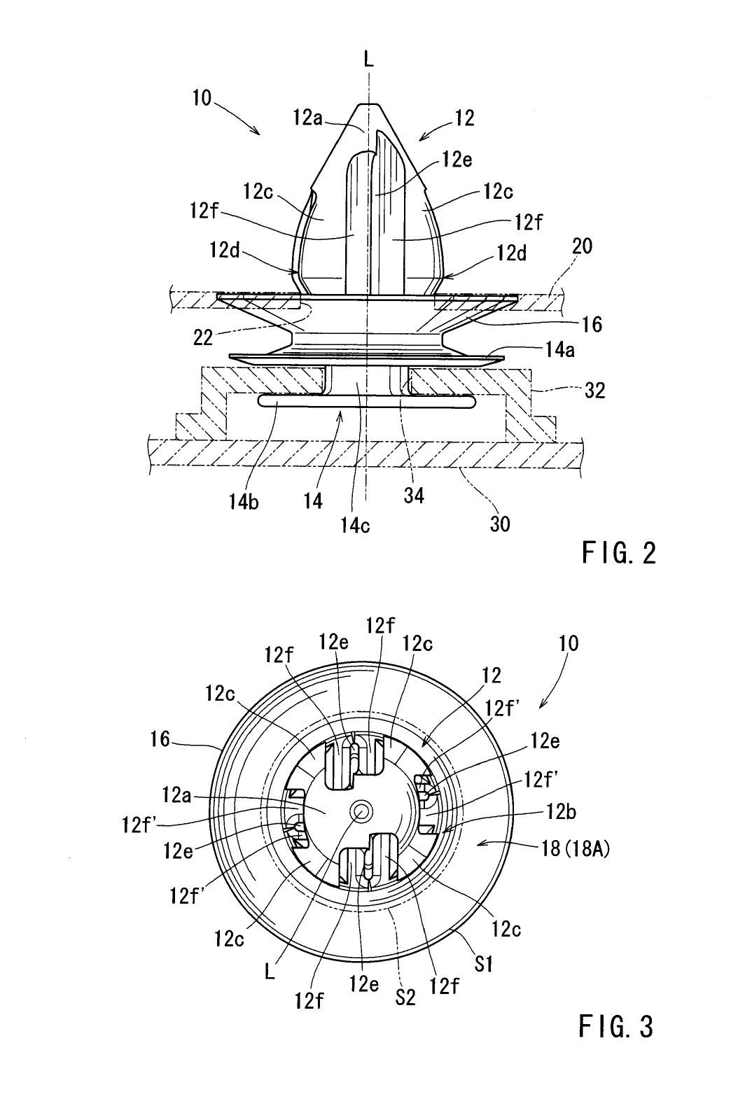

As best shown in FIG. 2, each of the flexible strip portions 12c has a shoulder portion 12d. The shoulder portion 12d is positioned adjacent to the proximal end portion 12b of the anchor portion 12 and is formed as a most outwardly projected portion. Therefore, as shown in FIG. 2, when the anchor portion 12 is pushed into an insertion hole 22 formed in a subject member 20 (e.g., a door inner panel) from an outer (lower) surface side of the subject member 20, the anchor portion 12 is introduced into the insertion hole 22 while the flexible strip portions 12c are respectively flexed inwardly, so as to be positioned in an inner (upper) surface side of the subject member 20. At this time, the flexible strip portions 12c are respectively restored, so that the shoulder portions 12d of the flexible strip portions 12c can engage a circumferential periphery of the insertion hole 22 in the inner surface side of the subject member 20, which will be hereinafter described. Thus, the anchor portion 12 securely coupled to the insertion hole 22, so that the resin clip 10 can be attached to the subject member 20.

The support strip portions 12e are respectively positioned between the flexible strip portions 12c, so as to not interfere with the flexible strip portions 12c. As best shown in FIG. 3, the support strip portions 12e may preferably be positioned to have a substantially cross-shape in transverse cross section. The support strip portions 12e can provide rigidity to the anchor portion 12, so as to prevent the anchor portion 12 from being bent. As shown in FIG. 3, formed between the flexible strip portions 12c and the support strip portions 12e are a plurality of (four in this embodiment) vertical recesses 12f that are diametrically oppositely positioned, and a plurality of (four in this embodiment) vertical recesses 12f′ that are diametrically oppositely positioned. As will be apparent from FIGS. 1 to 3, the vertical recesses 12f′ are different from the vertical recesses 12f in shape and size (depth and length) and respectively have relatively complicated shapes.

As will be recognized, the number and the shape of the flexible strip portions 12c and the support strip portions 12e can be changed, if necessary.

The connecting portion 14 is formed to be continuous with the proximal end portion 12b of the anchor portion 12. The connecting portion 14 may preferably include an upper (first) flange 14a, a lower (second) flange 14b, and a circular cylindrical portion 14c. The circular cylindrical portion 14c is positioned between the upper and lower flanges 14a and 14b and has a reduced diameter. As shown in FIG. 2, the connecting portion 14 is used to attach the resin clip 10 to an attaching member 30 (e.g., a door trim).

Further, as previously described, the resin clip 10 may preferably be integrally formed by the single-material molding using the molding die 40. However, the connecting portion 14 can be separately formed and can be connected to the proximal end portion 12b of the anchor portion 12. Also, the connecting portion 14 can be integrated with the proximal end portion 12b of the anchor portion 12 by two-material (two-color) molding or double molding.

As shown in FIG. 2, the attaching member 30 has an attachment portion 32 that is constructed to engage the connecting portion 14 of the resin clip 10. As will be appreciated, the attachment portion 32 is formed in an opposite surface (a rear surface) of a front (ornamental) surface of the attaching member 30. The attachment portion 32 has a slit 34 formed therein. Therefore, when the circular cylindrical portion 14c of the connecting portion 14 is pushed into the slit 34, the connecting portion 14 can be connected to the attachment portion 32 while the attachment portion 32 is interleaved between the upper and lower flanges 14a and 14b.

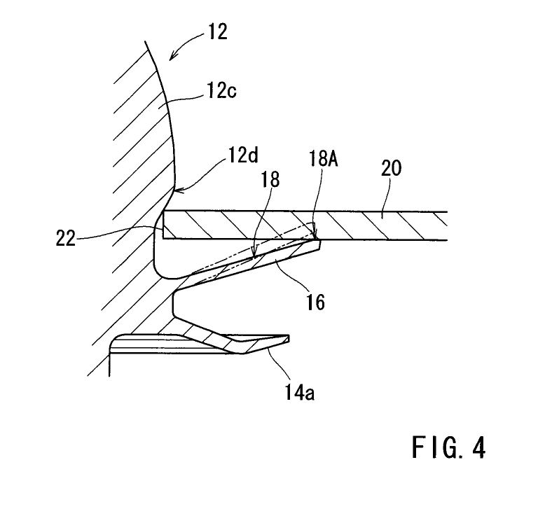

As best shown in FIG. 2, the disk portion 16 may preferably be formed as a circular dish-shaped portion. As best shown in FIG. 1, the dish-shaped disk portion 16 is positioned around the proximal end portion 12b of the anchor portion 12. The disk portion 16 is flared upwardly or diagonally extended upwardly and outwardly and has a substantial flexibility. Further, as best shown in FIG. 3, the disk portion 16 is concentrically positioned about the longitudinal axis L of the anchor portion 12. As will be recognized, when the anchor portion 12 is pushed into the insertion hole 22 formed in the subject member 20 (which is shown in FIG. 2 or 4) in order to attach the resin clip 10 to the subject member 20, the disk portion 16 can be pressed to a (lower) surface of the subject member 20 around the insertion hole 22, so as to be elastically deformed. Thus, the resin clip 10 can be stably attached to the subject member 20. As will be recognized, the disk portion 16 has a stabilizing function that can stabilize the resin clip 10 on the subject member 20 when the resin clip 10 is attached to the subject member 20. In addition, the disk portion 16 can hermetically contact the surface of the subject member 20 when elastically deformed. That is, the disk portion 16 also has a sealing function that can prevent water from entering the insertion hole 22.

Further, the disk portion 16 may have various shapes other than the circular shape, e.g., an ellipsoidal shape, an oval shape or other such shapes.

As will be appreciated, when the anchor portion 12 is pushed into the insertion hole 22, an upper (inner) surface 18 of the disk portion 16 can be pressed to the surface of the subject member 20. The upper surface 18 of the disk portion 16 has a sealing surface 18A that is capable of contacting the surface of the subject member 20. In this embodiment, the sealing surface 18A is formed in a portion of the upper surface 18 of the disk portion 16. In particular, the sealing surface 18A is formed between an outer peripheral portion S1 and an inner boundary portion S2 that are shown in FIGS. 1 and 3. The sealing surface 18A may preferably be formed as an annular smooth and flat surface without unevenness or roughness. The sealing surface 18A thus formed can be strongly pressed to the surface of the subject member 20 when the upper surface 18 of the disk portion 16 contacts the surface of the subject member 20, thereby functioning the sealing function (FIG. 4).

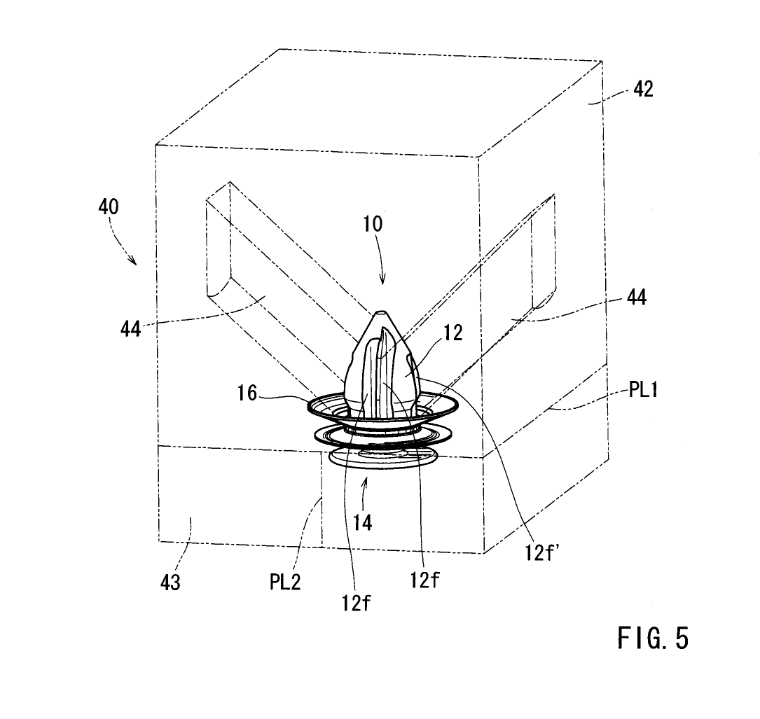

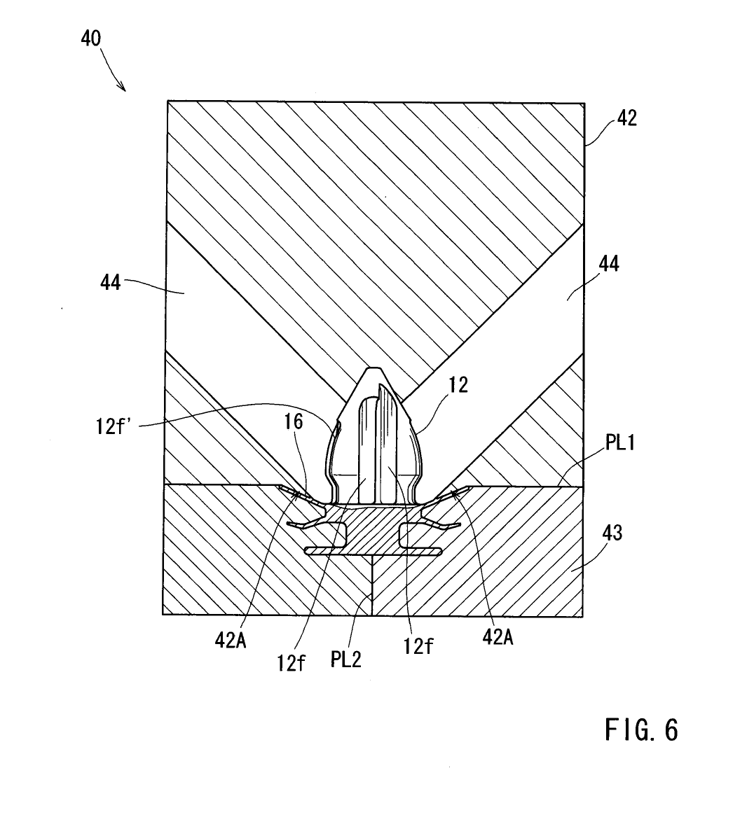

The resin clip 10 can be formed using the molding die 40 shown in FIGS. 5 and 6. The molding die 40 is composed of a single upper die element (a first main die part) 42, a pair of lower die elements (second main die parts) 43 and a pair of slide die elements (supplemental die parts) 44. The upper die element 42 and the lower die elements 43 are mated via a transverse mating portion PL1 and can be vertically opened. The lower die elements 43 are mated via a vertical mating portion PL2 and can be laterally opened. Further, the slide die elements 44 are laterally inserted into the upper die element 42 and can respectively be slid obliquely upwardly and downwardly.

As shown in FIG. 6, the upper die element 42 is constructed to form a profile of the anchor portion 12 and the upper surface 18 of the disk portion 16 and to simultaneously shape the (four) vertical recesses 12f. Conversely, as shown in FIG. 6, the lower die elements 43 are constructed to form the connecting portion 14 and a lower (outer) surface of the disk portion 16. Further, as shown in FIG. 6, the slide die elements 44 are constructed to shape the (four) vertical recesses 12f′ that cannot be formed by only the upper die element 42 because of the complicated shapes thereof.

The upper die element 42 has a molding space that is capable of exclusively forming the profile of the anchor portion 12 and shaping the vertical recesses 12f. The lower die elements 43 have a molding space that is capable of forming a profile of the connecting portion 14 and the disk portion 16 (the lower surface of the disk portion 16). Further, each of the slide die elements 44 has molding surfaces that are capable of forming the vertical recesses 12f′. As will be recognized, the number of the slide die elements 44 can be changed depending on the number of the vertical recesses 12f′.

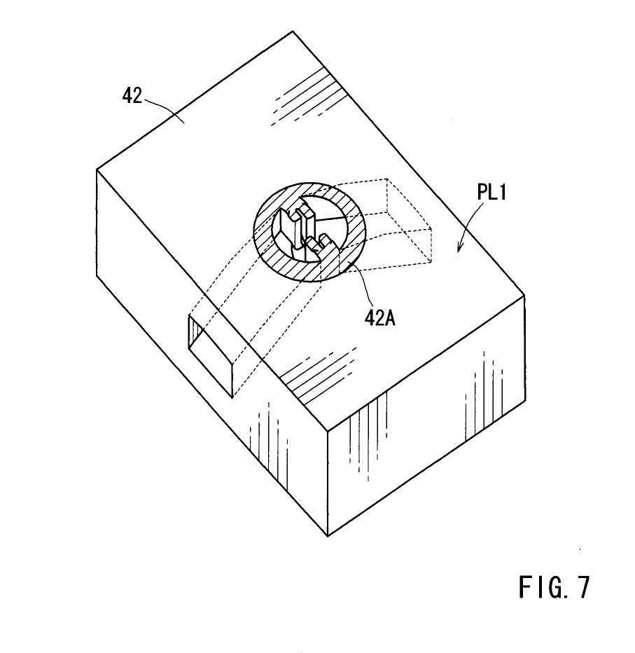

As shown in FIGS. 6 and 7, the upper die element 42 includes an annular molding surface 42A that is capable of forming the sealing surface 18A formed in the upper surface 18 of the disk portion 16. Further, in FIG. 7, the molding surface 42A is highlighted by hatching in order to clarify the area thereof. As will be apparent from FIG. 7, the molding surface 42A circumferentially continuously extends. Therefore, the sealing surface 18A of the disk portion 16 formed by the molding surface 42A can be formed as a smooth annular surface that circumferentially continuously extends and is centered on the longitudinal axis L of the anchor portion 12. Therefore, the sealing surface 18A is capable of continuously contacting the surface of the subject member 20 when the anchor portion 12 is inserted into the insertion hole 22 formed in the subject member 20.

According to the molding die 40 having the slide die elements 44, the resin clip 10 can be integrally formed by single-color (single-material) molding even though the resin clip 10 includes the anchor portion 12 having the specially-shaped vertical recesses 12f′. Further, according to the molding die 40, the sealing surface 18A of the disk portion 16 can be formed as the smooth annular surface that is centered on the longitudinal axis L of the anchor portion 12 because it is shaped by the molding surface 42A during the molding.

Thus, the molding die 40 having the slide die elements 44 is intended to make the resin clip 10 of which the anchor portion 12 has the specially-shaped vertical recesses 12f′ that cannot be formed without using the slide die elements 44. That is, the molding die 40 is not intended to make resin clips other than the resin clip 10, e.g., a resin clip having no anchor portion, a resin clip of which the anchor portion only has normally-shaped vertical recesses that can be easily formed without using the slide elements 44, and a resin clip that can be formed by two-color (two-material) molding.

Further, it should be noted that the sealing surface 18A of the disk portion 16 must circumferentially continuously contact the surface of the subject member 20 when the resin clip 10 is attached to the subject member 20 by inserting the anchor portion 12 into the insertion hole 22 formed in the subject member 20. Therefore, it is not essential that the sealing surface 18A of the disk portion 16 is circumferentially flattened or evened before the resin clip 10 is attached to the subject member 20.

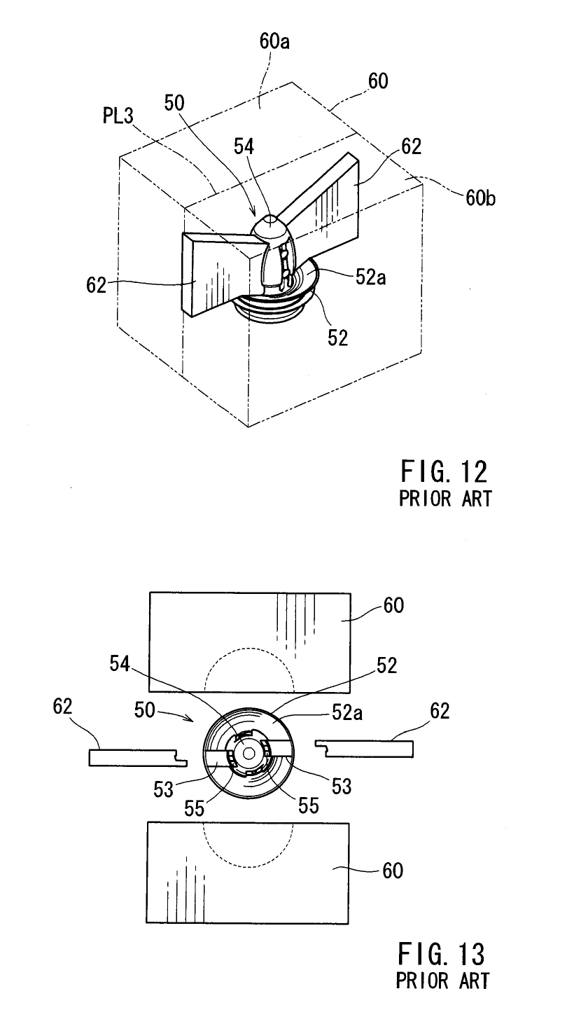

Now, a conventional molding die 60 for making a conventional resin clip 50 will be described with reference to FIGS. 12 and 13. The molding die 60 is composed of first and second die elements 60a and 60b that are laterally positioned, and a pair of slide die elements 62. The first die element 60a and the second die element 60b are mated via a vertical mating portion PL3 and can be laterally opened. The slide die elements 62 are laterally inserted into the first and second die elements 60a and 60b, so as to be slid obliquely upwardly after the first and second die elements 60a and 60b are opened.

The slide die elements 62 may function to form vertical recesses 55 (FIG. 13) formed in an anchor portion 54 of the resin clip 50. The slide die elements 62 may also function to shape a portion of an annular sealing surface 52a formed in a disk portion 52 of the resin clip 50. That is, each of the slide die elements 62 has molding surfaces that are capable of forming the vertical recesses 55 and an additional molding surface that is capable of forming the portion of the sealing surface 52a. Therefore, as shown in FIG. 13, when the slide die elements 62 are removed from the first and second die elements 60a and 60b after the first and second die elements 60a and 60b are opened, a pair of uneven portions 53 corresponding to the additional molding surface of the slide die elements 62 can be produced in the sealing surface 52a of the disk portion 52. The uneven portions 53 radially continuously extend on the disk portion 52 over the entire width thereof. As a result, the sealing surface 52a of the disk portion 52 can be circumferentially broken or divided by the uneven portions 53. Thus, sealing performance of the sealing surface 52a can be reduced.

To the contrary, as previously described, the sealing surface 18A of the disk portion 16 of the present embodiment can be formed by the molding surface 42A having the continuous annular shape. Therefore, the sealing surface 18A of the disk portion 16 can be circumferentially entirely evened or smoothened. That is, the sealing surface 18A of the disk portion 16 cannot be circumferentially broken or divided. As a result, when the resin clip 10 is attached to the subject member 20, the sealing surface 18A of the disk portion 16 can circumferentially continuously contact the surface of the subject member 20. Thus, the sealing surface 18A can have sufficient sealing performance.

Further, in the present embodiment, upon completion of the molding of the resin clip 10, the slide die elements 44 are respectively be slid obliquely upwardly. Thereafter, the upper die element 42 and the lower die elements 43 are vertically opened via the transverse mating portion PL1. Finally, the lower die elements 43 are laterally opened via the vertical mating portion PL2. Thus, the formed resin clip 10 can be released from the molding die 40.

In the present embodiment, the slide die elements 44 are constructed so as to be slid obliquely upwardly and downwardly. However, an inclination angle of each of the slide die elements 44 with respect to the horizontal line can be reduced when a depth of each of the vertical recesses 12f′ is shallow. Also, such an inclination angle of each of the slide die elements 44 can be reduced when a depth of the upper surface 18 of the disk portion 16 is shallow. Therefore, the molding die 40 can be designed such that the slide die elements 44 can respectively be slid substantially horizontally, if necessary. In such a case, the sealing surface 18A can be formed in the entire area of the upper surface 18 of the disk portion 16.

Next, a method of using the resin clip 10 will now be described in detail.

First, as shown in FIG. 2, the connecting portion 14 of the resin clip 10 is pushed into the slit 34 formed in the attachment portion 32 of the attaching member 30, so as to be connected to the attachment portion 32. Subsequently, the anchor portion 12 of the resin clip 10 is inserted into the insertion hole 22 formed in the subject member 20. Upon insertion of the anchor portion 12, the anchor portion 12 passes through the insertion hole 22 while the flexible strip portions 12c of the anchor portion 12 are respectively flexed toward the longitudinal axis L of the anchor portion 12, so that the shoulder portions 12d of the flexible strip portions 12c can engage the circumferential periphery of the insertion hole 22. Thus, the resin clip 10 can be attached to the subject member 20. As a result, the attaching member 30 can be attached to the subject member 20 via the resin clip 10.

In a condition in which the resin clip 10 is attached to the subject member 20, as previously described, the upper surface 18 of the disk portion 16 can be pressed to the surface of the subject member 20 around the insertion hole 22. At this time, the sealing surface 18A formed in the upper surface 18 can effectively circumferentially continuously contact the surface of the subject member 20 around the insertion hole 22 because the sealing surface 18A can be circumferentially continuously evened or smoothened. Thus, the sealing surface 18A can have the sufficient sealing performance around the insertion hole 22.

According to the present embodiment, the disk portion 16 of the resin clip 10 having the sufficient sealing performance can be integrally formed by single-color (single-material) molding. Therefore, it is not necessary to additionally provide a rubber packing to the disk portion 16 or to additionally form a sealing member made of an elastic material (e.g., elastomer) in the disk portion 16 by two-color molding. This may lead to reduced manufacturing costs of the resin clip 10. Further, sealing performance of the disk portion 16 can be reliably maintained because the disk portion 16 does not have the rubber packing or the sealing member that can be easily removed or separated therefrom.

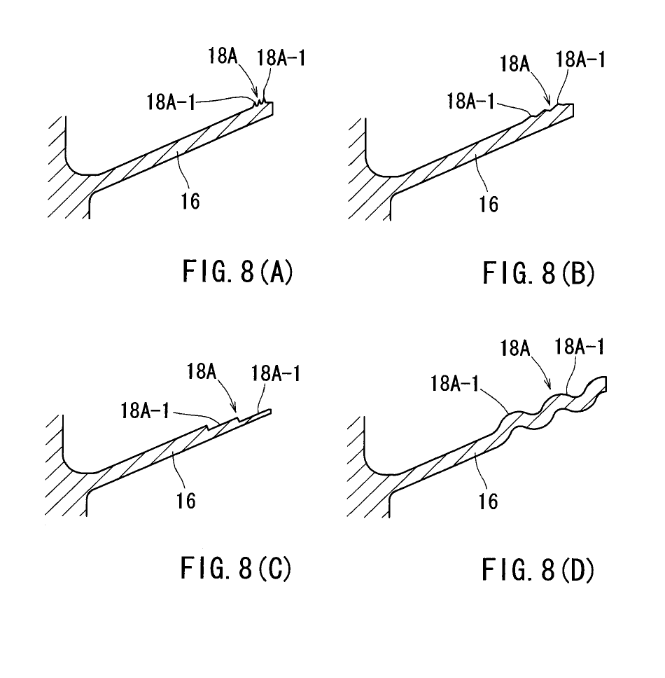

As will be recognized, the sealing surface 18A of the upper surface 18 is not limited to the annular smooth and even surface. That is, as shown in FIGS. 8(A) to 8(B), the sealing surface 18A can have a plurality of annular (circular) deformed portions (sealing performance increasing portions) 18A-1. The annular deformed portions 18A-1 may preferably be concentrically positioned about the longitudinal axis L of the anchor portion 12, so as to circumferentially continuously extend along a periphery of the sealing surface 18A. The annular deformed portions 18A-1 can be formed, for example, as annular blade-shaped portions (FIG. 8(A)), annular rib-shaped portions (FIG. 8(B)), annular flat shoulder portions (FIG. 8(C)) and annular corrugated portions (FIG. 8(D)).

According to the disk portion 16 having the annular deformed portions 18A-1 that are formed in the sealing surface 18A of the upper surface 18, when the upper surface 18 is pressed to the surface of the subject member 20, the sealing surface 18A can continuously contact the surface of the subject member 20 via the annular deformed portions 18A-1. Therefore, even when the surface of the subject member 20 is not evened or has contaminant materials adhered thereto, the sealing surface 18A can reliably continuously contact the surface of the subject member 20 without being affected by the unevenness of the surface of the subject member 20 or the contaminant substances adhered to the surface of the subject member 20.

Further, when the disk portion 16 has the ellipsoidal shape or the oval shape, the annular deformed portions 18A-1 may have the ellipsoidal shape or the oval shape that is centered on the longitudinal axis L of the anchor portion 12.

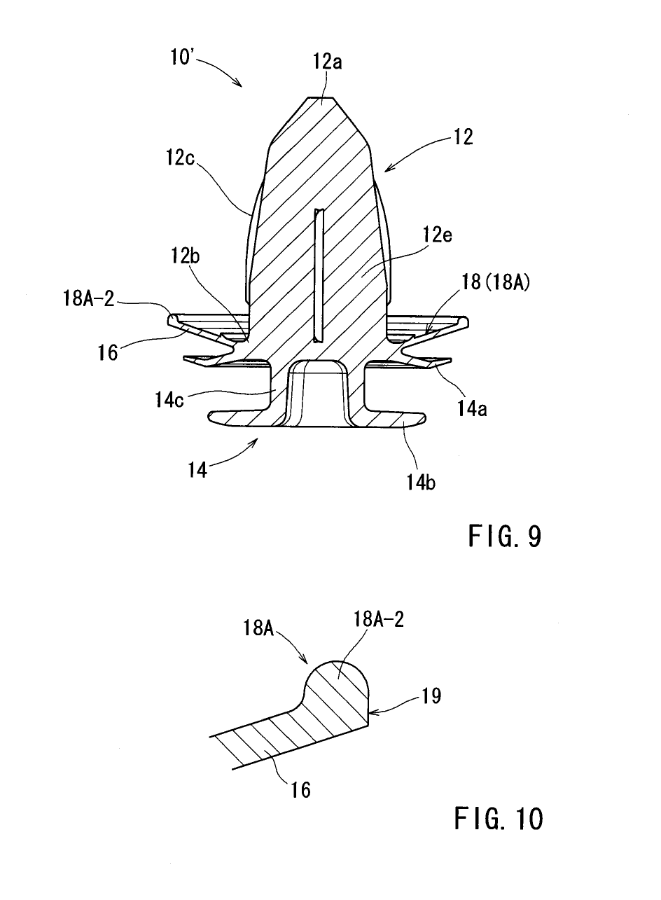

A second detailed representative embodiment will now described in detail with reference to FIGS. 9 to 11.

Because the second embodiment relates to the first embodiment, only the constructions and elements that are different from the first embodiment will be explained in detail. Elements that are the same in the first and second embodiments will be identified by the same reference numerals and a detailed description of such elements may be omitted.

Similar to the resin clip 10, a resin clip 10′ may preferably include the anchor portion 12, the connecting portion 14, and the disk portion 16. Further, the sealing surface 18A is formed in the upper surface 18 of the disk portion 16. However, in this embodiment, unlike the first embodiment, the disk portion 16 has an annular (circular) thickened reinforcement portion 18A-2 that continuously extends along an outer circumferential periphery thereof. The reinforcement portion 18A-2 may preferably have an annular rib-shape that is upwardly projected from the periphery of the sealing surface 18A. Thus, the disk portion 16 can be effectively reinforced by the reinforcement portion 18A-2, so as to be stabilized in shape. As a result, in the resin clip 10′, the sealing surface 18A can have further increased sealing performance. In addition, the resin clip 10′ can be further stabilized on the surface of the subject member 20 by the disk portion 16.

As best shown in FIG. 10, the reinforcement portion 18A-2 may preferably have a rounded or semi-circular main portion and a vertical linear side portion 19 in cross section. The rounded main portion is continuous with a lower surface of the disk portion 16 via the vertical linear side portion 19.

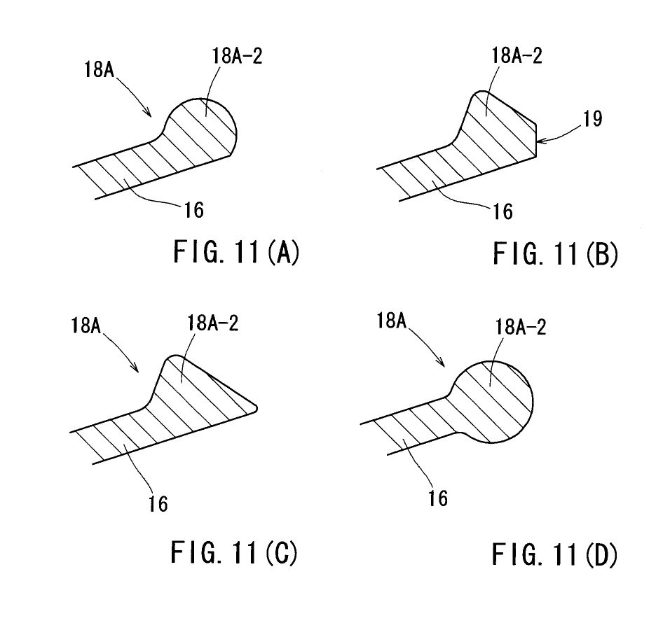

Further, as shown in FIGS. 11(A) to 11(B), the reinforcement portion 18A-2 can have various shapes in cross section. In the modified form shown in FIG. 11(A), the reinforcement portion 18A-2 has a circular arc main portion in cross section. The circular arc main portion is directly continuous with the lower surface of the disk portion 16. In the modified form shown in FIG. 11(B), the reinforcement portion 18A-2 has a rounded triangular main portion in cross section and the vertical linear side portion 19. The rounded triangular main portion is continuous with the lower surface of the disk portion 16 via the vertical linear side portion 19. In the modified form shown in FIG. 11(C), the reinforcement portion 18A-2 has a rounded triangular main portion in cross section. Unlike the modified form shown in FIG. 11(B), the rounded triangular main portion is directly continuous with the lower surface of the disk portion 16. Further, in the modified form shown in FIG. 11(D), the reinforcement portion 18A-2 has a substantially circular main portion in cross section. The circular main portion is directly continuous with the lower surface of the disk portion 16.

Naturally, various changes and modifications may be made to the present invention without departing from the scope of the invention. For example, in the second embodiment, the sealing surface 18A can have a plurality of annular deformed portions (sealing performance increasing portions) similar to the annular deformed portions 18A-1 shown in FIGS. 8(A) to 8(B).

Representative examples of the present invention have been described in detail with reference to the attached drawings. This detailed description is merely intended to teach a person of skill in the art further details for practicing preferred aspects of the present invention and is not intended to limit the scope of the invention. Only the claims define the scope of the claimed invention. Therefore, combinations of features and steps disclosed in the foregoing detail description may not be necessary to practice the invention in the broadest sense, and are instead taught merely to particularly describe detailed representative examples of the invention. Moreover, the various features taught in this specification may be combined in ways that are not specifically enumerated in order to obtain additional useful embodiments of the present invention.

What is claimed is:

1. A resin clip, comprising:
an anchor portion that is arranged and constructed to be inserted into an insertion hole formed in a subject member;
a disk portion that is positioned around a proximal end portion of the anchor portion; and
an annular sealing surface that is formed in the disk portion,
wherein the anchor portion and the disk portion are integrally formed as a unit by single-material molding using a molding die,
wherein a portion of the anchor portion is shaped by a supplemental die part of the molding die,
wherein the sealing surface is formed by a single main die part of the molding die and has a circumferentially continuous shape that is centered on a longitudinal axis of the anchor portion, and
wherein the disk portion is arranged and constructed to be pressed to the surface of the subject member when the anchor portion is inserted into the insertion hole of the subject member, so that the sealing surface can circumferentially continuously contact the surface of the subject member around the insertion hole.

2. The resin clip as defined in claim 1, wherein the sealing surface has a plurality of annular deformed portions that are concentrically positioned about the longitudinal axis of the anchor portion.

3. The resin clip as defined in claim 1, wherein the sealing surface has an annular thickened portion that continuously extends along an outer circumferential periphery thereof.

4. A method of manufacturing a resin clip having an anchor portion, a disk portion and an annular sealing surface formed in the disk portion, comprising:
integrally forming the anchor portion and the disk portion by single-material molding using a molding die;
shaping a portion of the anchor portion by a supplemental die part of the molding die, and
forming the sealing surface portion by a single main die part of the molding die,
wherein the main die part of the molding die includes a continuous annular molding surface, so as to form the sealing surface having a circumferentially continuous shape.
